(19) United States
(12) Patent Application Publication
(10) Pub. No.: US 2025/0166141 A1
(43) Pub. Date: May 22, 2025

(54) IMAGE RETOUCHING MODEL CONDITIONAL ON COLOR HISTOGRAMS

(71) Applicant: SAMSUNG ELECTRONICS CO., LTD., Gyeonggi-Do (KR)

(72) Inventors: Tingting Zhao, Irvine, CA (US); Chenguang Liu, Tustin, CA (US); Kamal Jnawali, Gainesville, VA (US); Chang Su, Foothill Ranch, CA (US)

(21) Appl. No.: 18/815,753

(22) Filed: Aug. 26, 2024

Related U.S. Application Data
(60) Provisional application No. 63/599,813, filed on Nov. 16, 2023.

(51) Int. Cl. G06T 5/77; G06T 5/40; G06T 5/60

(52) U.S. Cl. CPC G06T 5/77; G06T 5/40; G06T 5/60; G06T 2207/10024; G06T 2207/20072; G06T 2207/20081; G06T 2207/20084

(57) ABSTRACT

Image retouching includes receiving, by a conditional network, conditional information including one or more color histograms for an input image. The input image has a first coloration. The conditional network generates a plurality of scalar parameters based on the one or more color histograms. From the input image, an output image is generated by a base generative network. The output image has a second coloration different from the first coloration. One or more intermediate features generated by the base generative network are modulated based on the plurality of scalar parameters to generate the output image.

### CROSS-REFERENCE TO RELATED APPLICATIONS

This application claims the benefit of U.S. Application No. 63/599,813 filed on Nov. 16, 2023, which is fully incorporated herein by reference.

### TECHNICAL FIELD

This disclosure relates to image processing and, more particularly, to retouching images using an image retouching model conditioned on color histograms.

### BACKGROUND

Image retouching is a type of image processing that seeks to enhance certain aspects of an image. Often, image retouching refers to changing one or more aspects of the coloration of an image. The coloration of an image generally refers to the appearance of the image with respect to color. In this regard, image retouching may refer to any of a variety of color-related changes, modifications, corrections, and/or enhancements to an image. Examples of color-related features of an image that may be changed, modified, corrected, and/or enhanced can include, but are not limited to, brightness, contrast, color, saturation or shifted color, or the like.

Typically, image retouching is a manual process in which a human colorist applies certain retouching operations to an image based on the colorist's perceived intent of the creator of the image. This perceived intent is often derived from the content of the image and/or a particular aesthetic feel perceived by colorist from the image itself. The image retouching process, however, is often tedious and highly time-consuming. Further, the final coloration of retouched images may vary greatly from one colorist to another and, as such are highly dependent on the aesthetic choices made by the colorist and the colorist's personal preferences.

Automatic image editing tools have become increasingly popular. Some of the available automatic image editing tools utilize technologies such as learning-based networks including supervised generative networks. While such approaches may provide acceptable results, these results come at a high computational cost. Available automated image editing tools that utilize learning-based networks require significant computational resources rendering them unable to execute locally on a lightweight computing platform such as a mobile device. Further, the high computational requirements prevent such automated image editing tools from operating in real-time contexts or use cases.

### SUMMARY

In one or more embodiments, a method includes receiving, by a conditional network, conditional information including one or more color histograms for an input image. The input image has a first coloration. The method includes generating, by the conditional network and based on the one or more color histograms, a plurality of scalar parameters. The method includes generating, from the input image, an output image having a second coloration different from the first coloration using a base generative network. One or more intermediate features generated by the base generative network are modulated based on the plurality of scalar parameters to generate the output image.

In one or more embodiments, a system includes one or more processors, one or more computer-readable storage mediums, and computer-readable program instructions stored on the one or more computer-readable storage mediums to cause the one or more processors to perform operations. The operations include receiving, by a conditional network, conditional information including one or more color histograms for an input image. The input image has a first coloration. The operations include generating, by the conditional network and based on the one or more color histograms, a plurality of scalar parameters. The operations include generating, from the input image, an output image having a second coloration different from the first coloration using a base generative network. One or more intermediate features generated by the base generative network are modulated based on the plurality of scalar parameters to generate the output image.

In one or more embodiments, a computer program product includes one or more computer-readable storage mediums, and program instructions collectively stored on the one or more computer-readable storage mediums. The program instructions are executable by computer hardware to initiate operations. The operations include receiving, by a conditional network, conditional information including one or more color histograms for an input image. The input image has a first coloration. The operations include generating, by the conditional network and based on the one or more color histograms, a plurality of scalar parameters. The operations include generating, from the input image, an output image having a second coloration different from the first coloration using a base generative network. One or more intermediate features generated by the base generative network are modulated based on the plurality of scalar parameters to generate the output image.

This Summary section is provided merely to introduce certain concepts and not to identify any key or essential features of the claimed subject matter. Many other features and embodiments of the disclosed technology will be apparent from the accompanying drawings and from the following detailed description.

### BRIEF DESCRIPTION OF THE DRAWINGS

The accompanying drawings show one or more embodiments; however, the accompanying drawings should not be taken to limit the disclosed technology to only the embodiments shown. Various aspects and advantages will become apparent upon review of the following detailed description and upon reference to the drawings.

FIG. 1 illustrates an architecture for a generative machine learning (ML) model in accordance with one or more embodiments of the disclosed technology.

FIG. 2 illustrates an architecture for a conditional network of the generative ML model of FIG. 1 in accordance with one or more embodiments of the disclosed technology.

FIG. 3 illustrates an architecture for a multilayer perceptron network of the conditional network in accordance with one or more embodiments of the disclosed technology.

FIG. 4 illustrates an architecture for a base generative network of the generative ML model of FIG. 1 in accordance with one or more embodiments of the disclosed technology.

FIGS. 5A and 5B illustrate architectures for convolutional blocks of the base generative network in accordance with one or more embodiments of the disclosed technology.

FIG. 6 is a flow chart illustrating a method of operation for the generative ML model of FIG. 1 in accordance with one or more embodiments of the disclosed technology.

FIG. 7 illustrates an example implementation of a data processing system for use with the inventive arrangements described herein.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to image processing and, more particularly, to retouching images using an image retouching model conditioned on color histograms. In accordance with the inventive arrangements, methods, systems, and computer-program products are provided relating to a generative machine learning (ML) model capable of retouching images. The generative ML model is lightweight in nature in that the generative ML model may be executed by devices having limited computational capabilities such as mobile devices. In one or more embodiments, the generative ML model may operate in real-time or in near real-time on a lightweight computing device.

In general, the generative ML model is capable of receiving an input image to be processed and one or more color histograms of the input image. The color histogram(s) are provided, and used, as conditional information that guides network optimization. Conditional information in this context also may be referred to as “prior knowledge.” More particularly, conditional information in this context is data specifying prior knowledge in the form of one or more color histograms of an image to be processed. In one or more embodiments, the conditional information is data provided as input to a first network model and upon which the first network model operates to generate information that is provided to another, second network model to influence operation of the second network model. The second network model operates on another input where the operations performed on the input to the second network model are influenced or guided by the information generated by the first network model.

For example, the generative machine learning model may be formed of multiple networks including a conditional network and a base generative network. The conditional network receives the color histogram(s) as conditional information and encodes the conditional information into a plurality of feature modulation parameters also referred to herein as “scalar parameters.” The scalar parameters are provided to one or more layers of the base generative network. The scalar parameters may be provided to one or more hidden layers of the base generative network. The base generative network receives the scalar parameters and generates an output image based on the input image. The scalar parameters, as provided to the various layers of the base generative network, modulate intermediate results generated by the base generative network culminating in the output image.

The disclosed embodiments are capable of providing a high quality of result with respect to retouching an image. Retouching an image includes adjusting the coloration of an image. More particularly, the inventive arrangements are capable of providing equivalent or superior performance compared to state-of-the-art (SOTA) benchmarked models with a despite having a size that is a fraction of the size of such SOTA models. For purposes of illustration and not limitation, embodiments of the disclosed technology may be implemented with fewer than 7,000 parameters which is less than 25% of the size of many automated SOTA models trained to automatically retouch images. The lightweight nature of the embodiments described herein allows the technology to be integrated into a large range of applications across a variety of different types of devices of varying computational capabilities including those devices that are resource restricted or constrained.

Further aspects of the inventive arrangements are described below in greater detail with reference to the figures. For purposes of simplicity and clarity of illustration, elements shown in the figures are not necessarily drawn to scale. For example, the dimensions of some of the elements may be exaggerated relative to other elements for clarity. Further, where considered appropriate, reference numbers are repeated among the figures to indicate corresponding, analogous, or like features.

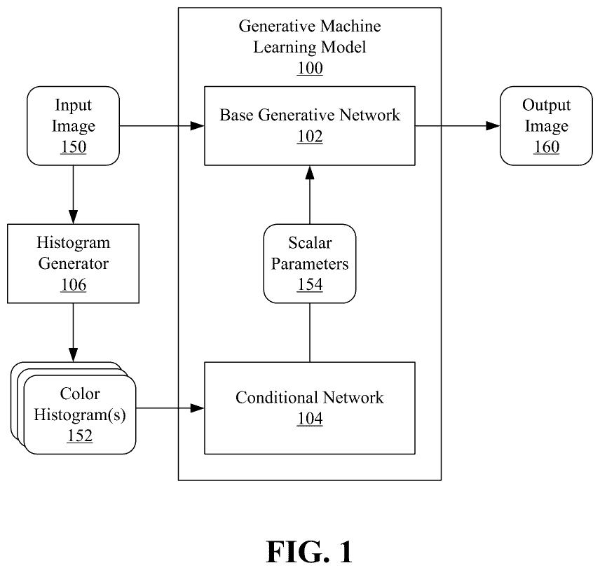

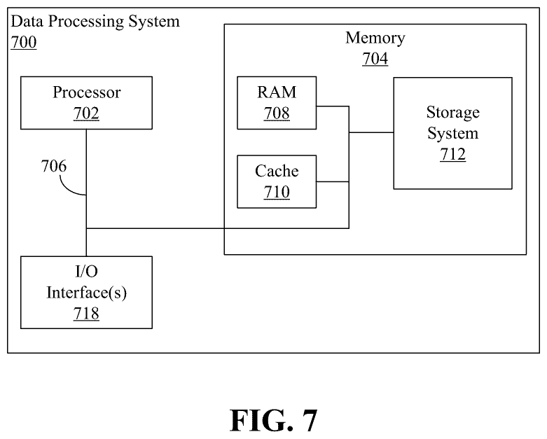

FIG. 1 illustrates an architecture for a generative ML model 100 in accordance with one or more embodiments of the disclosed technology. In the example of FIG. 1, generative ML model 100 may be implemented as a framework that is executable by a data processing system, e.g., a computer. In this regard, generative ML model 100 may be implemented as a combination of hardware and software, e.g., program code. An example of a data processing system capable of executing an architecture as illustrated in FIG. 1 is described in connection with FIG. 7. In one or more other embodiments, generative ML model 100 may be implemented in hardware such as in one or more integrated circuits (ICs) whether embodied as one or more special-purpose or Application-Specific ICs (ASICs), one or more programmable ICs, one or more SoCs, or the like.

In the example of FIG. 1, generative ML model 100 includes a base generative network 102 and a conditional network 104. As illustrated, base generative network 102 and conditional network 104 are coupled. For purposes of illustration, generative ML model 100 is trained to retouch images provided thereto as input. The processing of an input image 150 is depicted. Input image 150 may be a digital image such as a digital photo. It should be appreciated that while the inventive arrangements are described herein in connection with processing image, the inventive arrangements may be used to process video where each frame of video corresponds to an image that may be played in sequence. In this regard, input image 150 may be a frame of video. As illustrated, a histogram generator 106 is capable of generating one or more color histograms 152 from input image 150.

Histogram generator 106 is capable of generating color histograms 152 for a particular channel (e.g., a particular color). Each color histogram 152 generated will include the same or equal number of bins. As an illustrative and non-limiting example, each color histogram 152 may include 16 bins, though the inventive arrangements may operate with color histograms having a smaller or larger number of bins. Further, histogram generator 106 is capable of generating color histograms 152 for any of a variety of different color spaces. Examples of different color spaces include, but are not limited to, Red-Green-Blue or RGB color space, YUV (also referred to as “YCbCr” encoded) color space, the L*a*b* or CIELAB color space, or the like. For purposes of illustration, the RGB color space is used throughout this disclosure. In the example of FIG. 1, histogram generator 106 is capable of generating a red color histogram, a green color histogram, and a blue color histogram from input image 150.

Color histograms 152 are provided to conditional network 104 as conditional information. Conditional network 104 is capable of encoding the conditional information, e.g., the one or more color histograms 152, as a plurality of scalar parameters 154. Scalar parameters 154 are output from conditional network 104 and provided to base generative network 102. More particularly, conditional network 104 is capable of providing scalar parameters 154 to one or more layers of base generative network 102. In one or more embodiments, scalar parameters 154 are provided to one or more hidden layers of base generative network 102.

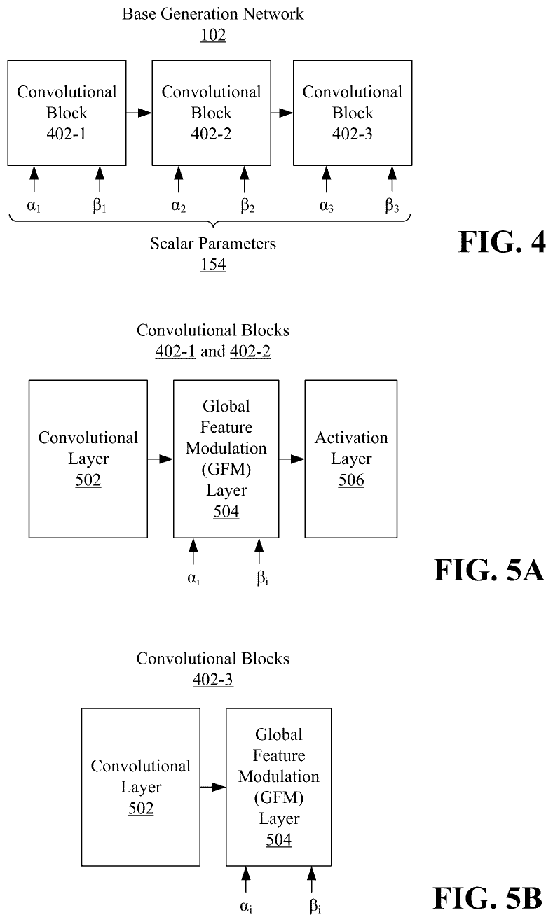

Base generative network 102 receives input image 150 and operates on input image 150 to generate output image 160. Operation of base generative network 102 is controlled and/or modulated based on scalar parameters 154. For example, various intermediate results generated by base generative network 102 may be changed or modulated based on scalar parameters 154 to generate output image 160. The particular manner in which intermediate features of base generative network 102 are modulated is described in greater hereinbelow in connection with FIGS. 4 and 5.

In the example of FIG. 1, generative ML model 100 may be trained on a set of training data in which a set of input training images have undergone retouching by adjusting coloration of the input training images to create a set of output training images used as ground truth images. In one or more examples, the ground truth images may be generated by a human being such as a colorist. The training process, which is described in greater detail hereinbelow, leverages observations that two different images that have similar color histograms may undergo similar coloration transformations for retouching purposes. The retouched versions of the two images, though of different content, will have similar changes in their respective color histograms.

The embodiments illustrated in FIG. 1 take a different approach from other automated color correction technologies that utilize machine learning. Conventional approaches that utilize conditional models attempt to extract conditional information implicitly from the input image itself. Such techniques often down-sample the input image and process that down-sampled input image through a network to generate global features that may be used to guide automated color correction. In many cases, owing to the size and complexity of the network, the particular features that are utilized to guide color correction may not be knowable or are not directly ascertainable.

The use of color histograms as described herein means that the particular features relied on for guiding color correction are known. Further, as color histograms may be generated using known image processing techniques that need not rely on machine learning/neural networks, the color histograms maybe generated quickly using relatively few computational resources in a low-dimensional space. These features allow the size of generative ML model 100 to be significantly reduced compared to other automated color correction networks and facilitates real-time operation of generative ML model 100.

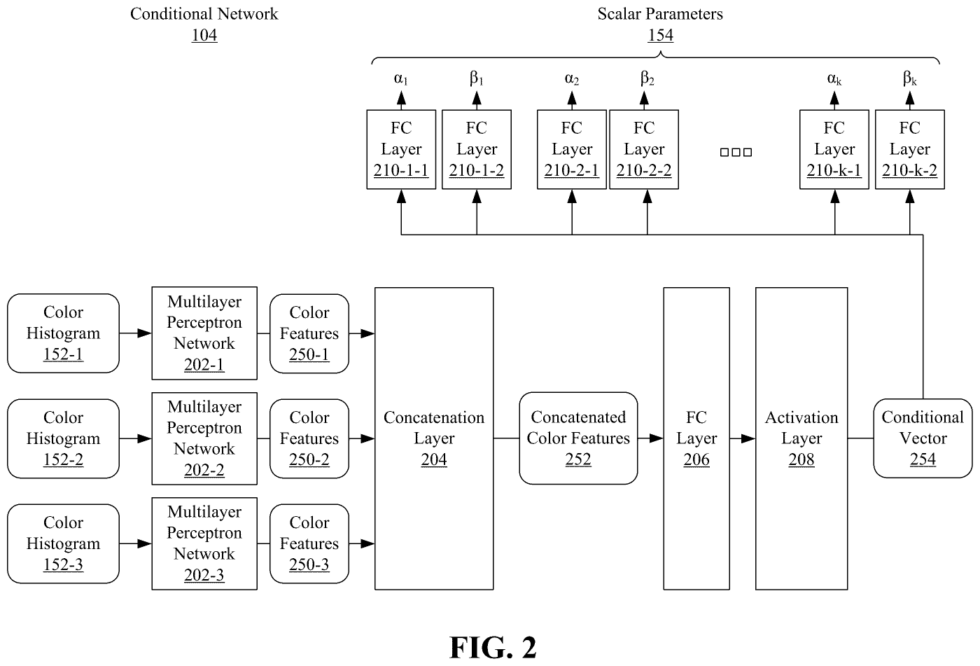

FIG. 2 illustrates an architecture for conditional network 104 of FIG. 1 in accordance with one or more embodiments of the disclosed technology. Conditional network 104 is implemented with a light-weight structure capable of converting the conditional information into scalar parameters for modulating intermediate features generated by base generative network 102. In the example of FIG. 2, conditional network 104 includes a plurality of multilayer perceptron networks 202, a concatenation layer 204, a fully connected (FC) layer 206, an activation layer 208, and a plurality of further fully connected layers 210.

Conditional network 104 may include one multilayer perceptron network 202 for each different channel of color histogram 152 provided. For purposes of illustration and continuing with the RGB color space example, multilayer perceptron network 202-1 may process the red color histogram (e.g., color histogram 152-1), multilayer perceptron network 202-2 may process the green color histogram (e.g., color histogram 152-2), and multilayer perceptron network 202-3 may process the blue color histogram (e.g., histogram 152-3). Appreciably, for other color spaces, the same relationship of using a different multilayer perceptron network to process each channel may be implemented.

For example, in the case of a YUV color space, conditional network 104 includes a multilayer perceptron network for the luma or brightness (Y), a multilayer perceptron for the chrominance component of the blue channel of an RGB image (U), and a multilayer perceptron for the chrominance component of the red channel of an RGB image (V). In the case of a CIELAB color space, conditional network 104 includes a multilayer perceptron network for the lightness (L*) ranging from 0 corresponding to pure black to 100 corresponding to pure white, a multilayer perceptron network for chromaticity from green to red (a*), and a multilayer perceptron network for chromaticity from blue to yellow (b*).

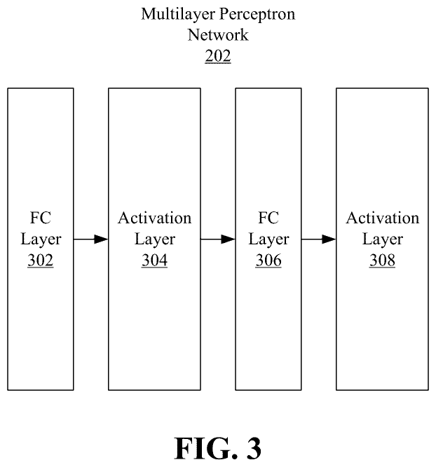

In the example of FIG. 2, multilayer perceptron networks 202 may operate in parallel and concurrently. A more detailed illustration of each multilayer perceptron network 202 is described in connection with FIG. 3. In general, the color distribution of each channel embodied as a color histogram having an equal number of bins is put into an individual multilayer perceptron network to generate color features 250.

In the example, to encode the prior knowledge of image color embodied as one or more color histograms 152, each multilayer perceptron network 202 generates a corresponding set of color features 250. Continuing with the RGB color space example, multilayer perceptron network 202-1 generates color features 250-1 for the color red based on color histogram 152-1. Multilayer perceptron network 202-2 generates color features 250-2 for the color green based on color histogram 152-2. Multilayer perceptron network 202-3 generates color features 250-3 for the color blue based on color histogram 152-3.

Concatenation layer 204 concatenates color features 250-1, color features 250-2, and color features 250-3 into concatenated color features 252. Concatenated color features 252 are processed by fully connected layer 206 and activation layer 208 to generate a conditional vector 254. In one or more embodiments, fully connected layer 206 includes six nodes and activation layer 208 may be implemented as a rectified linear unit (ReLU) layer.

In the example of FIG. 2, fully connected layers 210 are illustrated as pairs. In one or more embodiments, each fully connected layer 210 is capable of generating a particular scalar parameter for a particular layer of base generative network 102. Each fully connected layer 210-1-1, 210-2-1, and 210-k-1 generates an α scalar parameter that is specific to the particular convolutional block of base generative network 102 to which that parameter is provided. Each fully connected layer 210-1-2, 210-2-2, and 210-k-2 generates a β scalar parameter that is specific to the particular convolutional block of base generative network 102 to which that parameter is provided. Accordingly, each pair of fully connected layers (e.g., [210-1-1, 210-1-2], [210-2-1, 210-2-2], and [210-k-1, 210-k-2]) provides a particular convolutional block of base generative network 102 with a pair of scalar parameters α and β which may be used by the respective convolutional block to module intermediate features generated by that convolutional block. The modulation operation performed using scalar parameters 154 is described in greater detail below in connection with FIGS. 5A and 5B.

For purposes of illustration, consider an example in which generative network 102 includes three convolution blocks. In this example, fully connected layers 210-1, in reference to fully connected layers 210-1-1 and 210-1-2, generate scalar parameters for a first convolution block. Fully connected layers 210-2, in reference to fully connected layers 210-2-1 and 210-2-2, generate scalar parameters for a second convolution block, and fully connected layers 210-k, in reference to fully connected layers 210-k-1 and 210-k-2, generate scalar parameters for a k^{th} convolution block, which is the third convolutional block in this example. The right most digit indicates which scalar parameter is generated by the fully connected layer. For example, those ending with −1 generate the scalar parameter α, while those ending in −2 generate the scalar parameter β. In one or more embodiments, where base generative network 102 includes three convolution blocks, each of fully connected layers 210-1-1, 210-1-1, 210-2-1, and 210-2-2 is implemented with 64 nodes. Fully connected layers 210-k-1 and 210-k-2 (e.g., where k=3 in this example) are implemented with three nodes.

FIG. 3 illustrates an architecture for multilayer perceptron networks 202 in accordance with one or more embodiments of the disclosed technology. The example architecture illustrated in FIG. 3 may be used to implement one or more or each of multilayer perceptron networks 202-1, 202-2, and 202-3. In the example of FIG. 3, each multilayer perceptron network 202 includes a fully connected layer 302, followed by an activation layer 304, followed by another fully connected layer 306, followed by a further activation layer 308. In one or more embodiments, fully connected layer 302 includes 10 nodes and fully connected layer 306 includes 6 nodes. Activation layers 304 and 308 may be implemented as ReLU layers.

For purposes of illustration, a procedure for generating scalar parameters 154 is described below in accordance with one or more embodiments of the disclosed technology. For purposes of discussion, j represent a particular channel such as R, G, B in this example, and hⱼ represents a particular color histogram 152. Referring to FIGS. 2 and 3, for a given channel j, where j∈{1,2,3}, with an input histogram hⱼ, the output color features cⱼ corresponding to color features 250 generated by fully connected layers 302 and 306 are denoted in Expression 1. Expression 1 illustrates operation of fully connected layer 302 followed by activation layer 304, followed by fully connected layer 306, followed by activation layer 308. In Expression 1, fully connected layers have parameters {W_{1,j}^{c}, b_{1,j}^{c}} and {W_{2,j}^{c}, b_{2,j}^{c}}) and the activation layers 304, 308 are implemented using ReLU. In Expression 1, the superscript c indicates that the respective terms are for conditional network 104.

$${c}_{j} = Re LU ( {W}_{2 , j}^{c} Re LU ( {W}_{1 , j}^{c} {h}_{j} + {b}_{1 , j}^{c} ) + {b}_{2 , j}^{c} ) \qquad ( 1 )$$

The output color features {c₁, c₂, c₃} corresponding to color features 250 are concatenated into concatenated color features 252 denoted as C to generate condition vector 254 denoted as M. Fully connected layer 206 may have parameters {W₃^{c}, b₃^{c}}). Accordingly, conditional vector 254, e.g., M, may be denoted using Expression 2.

$$M = Re LU ( {W}_{3}^{c} C + {b}_{3}^{c} ) \qquad ( 2 )$$

The scalar parameters 154, also referred to as modulation parameters {αᵢ, βᵢ}, as used by convolutional blocks 402 in base generative network 102 are generated by fully connected layers 210 from conditional vector 254. For purposes of illustration, the fully connected layers 210 responsible for generating the αᵢ scalar parameters may be generated according to Expression 3 below.

$${α}_{i} = {W}_{4 , i , 1}^{c} + {b}_{4 , i , 1}^{c} \qquad ( 3 )$$

Within Expression 3 and Expression 4 below, subscript “1” indicates the parameter corresponds to the αᵢ scalar parameter and the subscript “2” indicates that the term corresponds to the βᵢ scalar parameter. The fully connected layers 210 responsible for generating the βᵢ scalar parameter may be generated according to Expression 4 below.

$${β}_{i} = {W}_{4 , i , 2}^{c} C + {b}_{4 , i , 2}^{c} \qquad ( 4 )$$

The scalar parameters may be generated in parallel by fully connected layers 210 and fed into the corresponding convolutional block of base generative network 102 to perform feature modulation as described in greater detail hereinbelow.

FIG. 4 illustrates an architecture for base generative network 102 in accordance with one or more embodiments of the disclosed technology. Base generative network 102 is capable of performing a pointwise transform based guidance obtained from the prior knowledge obtained from color histograms 152 encoded as scalar parameters 154. As noted, base generative network 102 may include k different convolutional blocks 402. For purposes of illustration and to continue with the prior example in which k=3, base generative network 102 includes convolutional blocks 402-1, 402-2, and 402-3. Each convolutional block 402 receives a corresponding set of scalar parameters specific to that particular convolutional block. For example, convolutional block 402-1 receives scalar parameters (α₁, β₁), convolutional block 402-2 receives scalar parameters (α₂, β₂), and convolutional block 402-3 receives scalar parameters (α₃, β₃).

FIGS. 5A and 5B illustrate architectures for convolutional blocks 402 of base generative network 102 in accordance with one or more embodiments of the disclosed technology. The example architecture illustrated in FIG. 5A may be used to implement convolutional blocks 402-1 and 402-2. In the example of FIG. 5A, the architecture includes a convolutional layer 502, followed by a global feature modulation (GFM) layer 504, followed by an activation layer 506. In one or more embodiments, convolutional layer 502 is implemented as a 1×1 convolutional layer.

For convolution layer 502, which may be implemented as a 1×1 convolution layer, the layer receives input features αᵢ and generates output features xᵢ in accordance with Expression 5 below.

$${x}_{i} = {W}_{i}^{b} {a}_{i} + {b}_{i}^{b} \qquad ( 5 )$$

In Expression 5, the trainable parameters are parameters Wᵢ^{b} and bᵢ^{b}. That is, Wᵢ^{b} is a trainable weight and bᵢ^{b} is a trainable bias. Within this disclosure, W is generally used to represent a weight and b to represent a bias. In this example, i represents the particular convolutional block 402 of base generative network 102. As discussed, the number of convolutional blocks in base generative network 102 may be three such that k=3. In the example, the superscript “b” indicates that the trainable parameters are for the base generative network 102.

GFM layer 504 is capable of receiving and applying scalar parameters 154, e.g., αᵢ and βᵢ, specific to that convolutional block. GFM layer 504 is capable of applying, or implementing, a modulation operation as an affine transformation of the convolution features using scalar parameters 154. The scalar parameters αᵢ and βᵢ received by GFM layer 504 are used in the respective convolutional block 402 to modulate the intermediate features xᵢ generated by convolution layer 502. GFM layer 504, for example, may implement Expression 6 below using scalar parameters 154.

$${\tilde{x}}_{ι} = {α}_{i} {x}_{i} + {β}_{i} \qquad ( 6 )$$

In Expression 6, as noted, xᵢ represents the intermediate features being modulated and the term [symbol] represents the modulated intermediate feature.

Activation layer 506 may be implemented as a ReLU layer. In one or more embodiments, activation layer 506 may implement Expression 7.

$${y}_{i} = {a}_{i + 1} = Re LU ( {\tilde{x}}_{ι} ) \qquad ( 7 )$$

As noted, convolutional blocks 402-1 and 402-2 of FIG. 4 may be implemented as illustrated and described in connection with FIG. 5A. In one or more embodiments, the final convolutional block 402-3 may be implemented differently. The final convolution block k of base generative network 102, e.g., convolutional block 402-3 in the example of FIG. 4, may be implemented to include convolutional layer 502 and GFM layer 504 and exclude the activation layer. That is, the convolutional block k is implemented to include only convolutional layer 502 and GFM layer 504. The example architecture illustrated in FIG. 5B may be used to implement convolutional block 402-3. In this respect, while convolutional blocks 402-1 and 402-2 may operate in a non-linear manner owing to the inclusion of an activation layer, convolutional block 402-3 may operate linearly.

In one or more embodiments, generative ML model 100 is trained such that base generative network 102 and conditional network 104 are trained jointly. For example, as part of a single training process, base generative network 102 and conditional network 104 are trained concurrently. For purposes of illustration, Table 1 below illustrates the parameters from Expressions 1-5 that are trainable. Expressions 6 and 7 do not include trainable parameters.

TABLE 1

| Expression | Trainable Parameter(s) |
|---|---|
| 1 | W_{2, j}^{c}, W_{1, j}^{c}, b_{1, j}^{c}, and b_{2, j}^{c} |
| 2 | W₃^{c}C and b₃^{c} |
| 3 | W_{4, i, 1}^{c} and b_{4, i, 1}^{c} |
| 4 | W_{4, i, 2}^{c} and b_{4, i, 2}^{c} |
| 5 | Wᵢ^{b} and bᵢ^{b} |

In one or more embodiments, generative ML model 100 is trained by minimizing a loss function denoted as L. The loss function L accounts for various metrics that may include, but are not limited to, pixel error, structural similarity index measure (SSIM), cosine error, and feature reconstruction error (also referred to as perceptual loss). An example of the loss function L is illustrated below as Expression 8.

$$L = {L}_{pix} ( {I}_{gt} , {I}_{gen} ) + {τ}_{1} {L}_{ssim} ( {I}_{gt} , {I}_{gen} ) + {τ}_{2} {L}_{cos} ( {I}_{gt} , {I}_{gen} ) + {τ}_{3} {L}_{feature} ( {I}_{gt} , {I}_{gen} ) \qquad ( 8 )$$

In Expression 8, Lₚᵢₓ specifies the pixel error, Lₛₛᵢₘ specifies the structural similarity index measure (SSIM), L_{cos} specifies the cosine error, and L_{feature} specifies the feature reconstruction error. The term τ is a scaling factor that controls the contribution of each type of error in the overall loss function L. τ may be set to a value between zero and one. In the example, the pixel error Lₚᵢₓ provides the largest contribution as no scaling factor τ is used. In one or more other embodiments, a scaling factor may be applied to pixel error Lₚᵢₓ.

Expression 8 provides a measure of loss or difference between a ground truth image I_{gt} and a retouched or generated image I_{gen} as output from generative ML model 100 and, more particularly, base generative network 102. Base generative network 102 generates I_{gen} from an input image Iᵢₙ. In this nomenclature, Iᵢₙ is the input image that is of low-quality requiring retouching or color modification. In this example, the ground truth image I_{gt} is version of Iᵢₙ that is retouched. The retouching may be performed by a human being, e.g., a colorist, through a manual process. In other examples, the retouching may be performed using any of a variety of automated processes. In Expressions 9 and 10 below, I_{gen} is generated by base generative network 102, denoted as G, which is guided by color histogram hⱼ as encoded by conditional network 104, denoted as C.

$${I}_{gen} = G ( {I}_{in} , {\{ {W}_{i}^{b} , {b}_{i}^{b} \}}_{i = 1 , … K} , {\{ {α}_{i} , {β}_{i} \}}_{i = 1 , … K} ) \qquad ( 9 )$$

$$( 10 )$$

$$\{ {α}_{i} , {β}_{i} \} = C ( {\{ {h}_{j} \}}_{j = 1 , 2 , 3} , {\{ {W}_{1 , j}^{c} , {b}_{1 , j}^{c} , {W}_{2 , j}^{c} , {b}_{2 , j}^{c} \}}_{j = 1 , 2 , 3} , {W}_{3}^{c} , {b}_{3}^{c} , \{ {W}_{4 , i , 1}^{c} , {b}_{4 , i , 1}^{c} , {W}_{4 , i , 2}^{c} , {b}_{4 , i , 2}^{c} \} )$$

The individual errors, also referred to as error metrics, included in the loss function L are described in greater detail below. The pixel error Lₚᵢₓ is given by Expression 11. In Expression 11, C, H, and W represent channel size, height, and width of the image respectively.

$${L}_{pix} ( {I}_{gt} , {I}_{gen} ) = \frac{1}{CHW} {‖ {I}_{gf} - {I}_{gen} ‖}_{1} \qquad ( 11 )$$

The SSIM error Lₛₛᵢₘ is given by Expression 12. In Expression 12, Ω is the image spatial field. SSIM seeks to measure the quality of an image by comparing the image to a reference image. SSIM is a full-reference metric in that the SSIM metric requires two images from the same capture. One of the image is processed and the other image is a reference. SSIM arises from the notion that image distortion is a combination of luminance distortion, contrast distortion, and loss of correlation and is correlated with human perception of image quality.

$${L}_{ssim} ( {I}_{gt} , {I}_{gen} ) = 1 - \frac{1}{CHW} {\sum }_{p ∈ Ω , c = 1 , … , C} ssim ( p , c ) \qquad ( 12 )$$

The Cosine Error L_{cos} is given by Expression 13. In expression 13, [symbol] I_{gt}(p), I_{gen}(p) [symbol] is the inner product and ϵ is a small number such as, for example, 10⁻⁶.

$${L}_{cos} ( {I}_{gt} ( p ) , {I}_{gen} ( p ) ) = \frac{〈 {I}_{gt} ( p ) , {I}_{gen} ( p ) 〉}{max ( {‖ {I}_{gt} ‖}_{1} {‖ {I}_{gen} ‖}_{1} , ϵ )} \qquad ( 13 )$$

The feature reconstruction loss error is given by Expression 14. In Expression 14, ϕⱼ is the Feature output from the j^{th} convolutional layer of VGG19 network, and Dⱼ is the size of the feature map ϕⱼ. Feature reconstruction loss error seeks to measure the discrepancy between original input features and reconstructed features produced by a model.

$${L}_{feature} ( {I}_{gt} , {I}_{gen} ) = 1 - \frac{1}{{\sum }_{j = 1 , … , K} {D}_{j}} {\sum }_{j = 1 , … , K} {‖ {ϕ}_{j} ( {I}_{gt} ) - {ϕ}_{j} ( {I}_{gen} ) ‖}_{1} \qquad ( 14 )$$

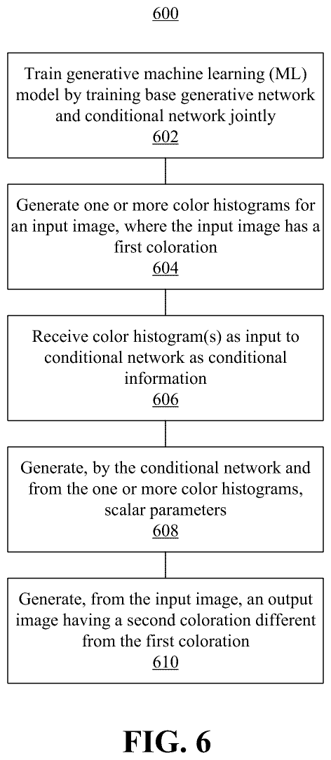

FIG. 6 is a flow chart illustrating a method 600 of operation for the generative ML model 100 of FIG. 1 in accordance with one or more embodiments of the disclosed technology.

In block 602, generative ML model 100 is trained. Generative ML model 100 may be trained by training base generative network 102 and conditional network 104 jointly. The training process may train base generative network 102 and conditional network 104 jointly (e.g., concurrently through a single, unified training process) by minimizing a loss function.

An example loss function that may be used is described in connection with Expression 8. The loss function may include one or more different error metrics. One or more or each error metric also may be scaled or weighted to control the amount of contribution of that error metric to the overall loss function. For example, the loss function can include a pixel error between a ground truth image and a version of a training image output from the base generative network. In another example, the loss function includes a structural similarity error between a ground truth image and a version of a training image output from the base generative network. In another example, the loss function includes a cosine error. In another example, the loss function includes a feature reconstruction error. It should be appreciated that the loss function may include any combination of the foregoing error metrics including each such error metric. Each error metric is calculated between a version of a training image output from the base generative network and a ground truth version of the training image.

The training process may be iterated to minimize the selected loss function. The particular parameters of base generative network 102 and conditional network 104 that are trained or that are trainable include those described herein in connection with Table 1. The various parameters may be updated through the training process to adjust the trainable parameters of Table 1 to reduce the error using the loss function.

Backpropagation of errors is an example training process for use in training generative ML model 100. A training input image is presented to generative ML model 100 for processing. The output of generative ML model 100 is compared to the desired output using the loss function and an error values are calculated that may be propagated backwards through generative ML model 100. Error values for the neurons represent each neuron's contribution to the output that is generated. Generative ML model 100 may then learn from those errors using an algorithm, such as the stochastic gradient descent algorithm, to update the trainable parameters of generative ML model 100.

In block 604, one or more color histograms 152 are generated for input image 150. Input image 150 has a first coloration. For example, histogram generator 106 may generate one or more color histograms 152. As noted, histogram generator 106 may be separate or independent of generative ML model 100. Color histograms 152 may be for one or more different channels. For example, each color histogram 152 may be for a different channel. In one or more embodiments, the one or more color histograms 152 correspond to one or more color spaces. Examples of the color spaces that may be used may include, but are not limited to, an RGB color space, a YUV color space, or a CIELAB color space.

In block 606, color histograms 152 are provided to conditional network 104 as conditional information. In block 608, conditional network 104 is capable of generating, based on the one or more color histograms 152, a plurality of scalar parameters 154. As described in connection with FIG. 2, in one or more embodiments, conditional network 104 includes one multilayer perceptron network for each color histogram 152 of a different channel.

In block 610, base generative network 102 is capable of generating, from input image 150, an output image 160 having a second coloration that is different from the first coloration. In generating output image 160 from the input image 150, one or more intermediate features generated by base generative network 102 are modulated based on the plurality of scalar parameters 154 generated by conditional network 104. In one or more embodiments, base generative network 102 includes a plurality of convolutional blocks 402. Each convolutional block 402 receives one or more scalar parameters of the plurality of scalar parameters 154. For example, as described in connection with FIGS. 5A and 5B, the GFM layer of each convolutional block 402 may receive its own set, or convolutional block-specific set, of scalar parameters that are used to modulate the features generated by that convolutional block.

FIG. 7 illustrates an example implementation of a data processing system 700. As defined herein, the term “data processing system” means one or more hardware systems configured to process data. Each hardware system includes at least one processor and memory, wherein the processor is programmed with computer-readable program instructions that, upon execution, initiate operations. Data processing system 700 can include a processor 702, a memory 704, and a bus 706 that couples various system components including memory 704 to processor 702.

Processor 702 may be implemented as one or more processors. In an example, processor 702 is implemented as a hardware processor such as a central processing unit (CPU). Processor 702 may be implemented as one or more circuits capable of carrying out instructions contained in program code. The circuit(s) may be an IC or embedded in an IC. Processor 702 may be implemented using a complex instruction set computer architecture (CISC), a reduced instruction set computer architecture (RISC), a vector processing architecture, or other known architectures. Example processors include, but are not limited to, processors having an x86 type of architecture (IA-32, IA-64, etc.), Power Architecture, ARM processors, and the like.

Bus 706 represents one or more of any of a variety of communication bus structures. By way of example, and not limitation, bus 706 may be implemented as a Peripheral Component Interconnect Express (PCIe) bus. Data processing system 700 typically includes a variety of computer system readable media. Such media may include computer-readable volatile and non-volatile media and computer-readable removable and non-removable media.

Memory 704 can include computer-readable media in the form of volatile memory, such as random-access memory (RAM) 708 and/or cache memory 710. Data processing system 700 also can include other removable/non-removable, volatile/non-volatile computer storage media. By way of example, storage system 712 can be provided for reading from and writing to a non-removable, non-volatile magnetic and/or solid-state media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 706 by one or more data media interfaces. Memory 704 is an example of at least one computer program product.

Memory 704 is capable of storing computer-readable program instructions that are executable by processor 702. For example, the computer-readable program instructions can include an operating system, one or more application programs, other program code, and program data. Processor 702, in executing the computer-readable program instructions, is capable of performing the various operations described herein that are attributable to a computer. In one or more examples, the computer-readable program instructions may implement the example architecture of FIG. 1 and/or perform the various blocks described in connection with FIG. 6.

Data processing system 700 may include one or more Input/Output (I/O) interfaces 718 communicatively linked to bus 706. I/O interface(s) 718 allow data processing system 700 to communicate with one or more external devices and/or communicate over one or more networks such as a local area network (LAN), a wide area network (WAN), and/or a public network (e.g., the Internet). Examples of I/O interfaces 718 may include, but are not limited to, network cards, modems, network adapters, hardware controllers, etc. Examples of external devices also may include devices that allow a user to interact with data processing system 700 (e.g., a display, a keyboard, and/or a pointing device) and/or other devices such as accelerator card.

Data processing system 700 is only one example implementation. Data processing system 700 can be practiced as a standalone device such as a user computing device, a mobile computing device such as a mobile phone or smartphone, a wearable computing device (e.g., smart glasses), a portable computing device, a laptop, a tablet, or the like. As discussed, any of a variety of computing and/or mobile devices including those that are resource constrained may be used.

In one or more other embodiments, though the inventive arrangements may be executed using resource constrained computing devices, the inventive arrangements also may be executed by other, more powerful computing devices such as a server, a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

The example of FIG. 7 is not intended to suggest any limitation as to the scope of use or functionality of example implementations described herein. Data processing system 700 is an example of computer hardware that is capable of performing the various operations described within this disclosure. In this regard, data processing system 700 may include fewer components than shown or additional components not illustrated in FIG. 7 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

The terminology used herein is for the purpose of describing particular embodiments only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of a computer-readable storage medium or two or more computer-readable storage mediums. A non-exhaustive list of examples of a computer-readable storage medium include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a double-data rate synchronous dynamic RAM memory (DDR SDRAM or “DDR”), a portable compact disc read-only memory (CD-ROM), a digital versatile disk (DVD), a memory stick, a floppy disk, or the like.

As defined herein, the phrase “in response to” and the phrase “responsive to” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the term “user” refers to a human being.

As defined herein, the term “hardware processor” means at least one hardware circuit. The hardware circuit may be configured to carry out instructions contained in program code. The hardware circuit may be an integrated circuit. Examples of a hardware processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a controller, and a Graphics Processing Unit (GPU).

As defined herein, the terms “one embodiment,” “an embodiment,” “one or more embodiments,” “particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” or “outputting” means storing in physical memory elements, e.g., devices, writing to display or other peripheral output device, sending or transmitting to another system, exporting, or the like.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

A computer program product may include a computer-readable storage medium (or mediums) having computer-readable program instructions thereon for causing a processor to carry out aspects of the inventive arrangements described herein. Within this disclosure, the terms “program code,” “program instructions,” and “computer-readable program instructions” are used interchangeably. Computer-readable program instructions described herein may be downloaded to respective computing/processing devices from a computer-readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives program instructions from the network and forwards the computer-readable program instructions for storage in a computer-readable storage medium within the respective computing/processing device.

Program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object-oriented programming language and/or procedural programming languages. Program instructions may include state-setting data. The program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the program instructions by utilizing state information of the program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by program instructions, e.g., program code.

These program instructions may be provided to a processor of a computer, special-purpose computer, or other programmable data processing apparatus to produce a machine, such that the program instructions, which execute via the processor of the computer or other programmable data processing apparatus, create means for implementing the functions/acts specified in the flowchart and/or block diagram block or blocks. These program instructions may also be stored in a computer-readable storage medium that can direct a computer, a programmable data processing apparatus, and/or other devices to function in a particular manner, such that the computer-readable storage medium having program instructions stored therein comprises an article of manufacture including program instructions which implement aspects of the operations specified in the flowchart and/or block diagram block or blocks.

The program instructions may also be loaded onto a computer, other programmable data processing apparatus, or other device to cause a series of operations to be performed on the computer, other programmable apparatus or other device to produce a computer implemented process, such that the program instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more program instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and program instructions.

The descriptions of the various embodiments of the disclosed technology have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a conditional network, conditional information including one or more color histograms for an input image, wherein the input image has a first coloration;
generating, by the conditional network and based on the one or more color histograms, a plurality of scalar parameters; and
generating, from the input image, an output image having a second coloration different from the first coloration using a base generative network, wherein one or more intermediate features generated by the base generative network are modulated based on the plurality of scalar parameters to generate the output image.

2. The method of claim 1, wherein the one or more color histograms are for one or more different channels.

3. The method of claim 2, wherein the one or more color histograms correspond to one or more color spaces.

4. The method of claim 3, wherein the one or more color spaces includes at least one of a Red-Green-Blue (RGB) color space, a YUV color space, or a CIELAB color space.

5. The method of claim 1, wherein the base generative network and the conditional network are trained jointly by minimizing a loss function.

6. The method of claim 5, wherein the loss function includes a pixel error between a ground truth image and a version of a training image output from the base generative network.

7. The method of claim 5, wherein the loss function includes a structural similarity error between a ground truth image and a version of a training image output from the base generative network.

8. The method of claim 5, wherein the loss function includes at least one of a cosine error or a feature reconstruction error, wherein each error is calculated between a version of a training image output from the base generative network and a ground truth version of the training image.

9. The method of claim 1, wherein the conditional network includes a multilayer perceptron network for each histogram of a different channel.

10. The method of claim 1, wherein the base generative network includes a plurality of convolutional blocks, wherein each convolutional block receives one or more scalar parameters of the plurality of scalar parameters.

11. A system, comprising:
one or more processors;
one or more computer-readable storage mediums; and
computer-readable program instructions stored on the one or more computer-readable storage mediums to cause the one or more processors to perform operations comprising:
receiving, by a conditional network, conditional information including one or more color histograms for an input image, wherein the input image has a first coloration;
generating, by the conditional network and based on the one or more color histograms, a plurality of scalar parameters; and
generating, from the input image, an output image having a second coloration different from the first coloration using a base generative network, wherein one or more intermediate features generated by the base generative network are modulated based on the plurality of scalar parameters to generate the output image.

12. The system of claim 11, wherein the one or more color histograms are for one or more different channels.

13. The system of claim 12, wherein the one or more color histograms correspond to one or more color spaces.

14. The system of claim 13, wherein the one or more color spaces includes at least one of a Red-Green-Blue (RGB) color space, a YUV color space, or a CIELAB color space.

15. The system of claim 14, wherein the base generative network and the conditional network are trained jointly by minimizing a loss function.

16. The system of claim 15, wherein the loss function includes a pixel error between a ground truth image and a version of a training image output from the base generative network.

17. The system of claim 15, wherein the loss function includes a structural similarity error between a ground truth image and a version of a training image output from the base generative network.

18. The system of claim 15, wherein the loss function includes at least one of a cosine error or a feature reconstruction error, wherein each error is calculated between a version of a training image output from the base generative network and a ground truth version of the training image.

19. The system of claim 11, wherein the conditional network includes a multilayer perceptron network for each histogram of a different channel; and
wherein the base generative network includes a plurality of convolutional blocks, wherein each convolutional block receives one or more scalar parameters of the plurality of scalar parameters.

20. A computer program product, comprising:
one or more computer-readable storage mediums, and program instructions collectively stored on the one or more computer-readable storage mediums, wherein the program instructions are executable by computer hardware to initiate operations including:
receiving, by a conditional network, conditional information including one or more color histograms for an input image, wherein the input image has a first coloration;
generating, by the conditional network and based on the one or more color histograms, a plurality of scalar parameters; and
generating, from the input image, an output image having a second coloration different from the first coloration using a base generative network, wherein one or more intermediate features generated by the base generative network are modulated based on the plurality of scalar parameters to generate the output image.
